(19) United States
(12) Patent Application Publication
(10) Pub. No.: US 2025/0160556 A1
(43) Pub. Date: May 22, 2025

(54) Vertical Juicing Mechanism And Juice Machine

(71) Applicant: ZHONGSHAN JIMI ELECTRICAL APPLIANCE CO., LTD, Zhongshan (CN)

(72) Inventor: Tao Wang, Zhongshan (CN)

(21) Appl. No.: 18/947,399

(22) Filed: Nov. 14, 2024

(30) Foreign Application Priority Data
Nov. 17, 2023 (CN) 202323117798.1

(51) Int. Cl. A47J 19/02

(52) U.S. Cl. CPC A47J 19/027

(57) ABSTRACT

A vertical juicing mechanism and a juice machine including the same are described. The vertical juicing mechanism includes: a juicing cup, where a separator is provided in the juicing cup, the separator divides the juicing cup into a cutting cavity and a grinding cavity located below the cutting cavity, and a discharge port communicating the cutting cavity with the grinding cavity is provided on the separator; a feed impeller, located within the cutting cavity; and a spiral propeller, located within the grinding cavity and provided coaxially with the feed impeller to drive the feed impeller to rotate together, where a stop plane is provided at an upper end of the spiral propeller, a limit portion opposite to the stop plane is provided at a lower end face of the separator.

### CROSS-REFERENCE TO RELATED APPLICATION(S)

This application claims priority from Chinese Patent Application No. 202323117798.1, filed on 17 Nov. 2023, the entire disclosure of which is incorporated by reference herein.

### TECHNICAL FIELD

The present disclosure relates to a vertical juicing mechanism and a juice machine.

### BACKGROUND

At present, with the continuous improvement of people's living standard, the juice machine has been widely used in people's daily life. The juice machine includes a juicing cup and a spiral propeller, and a spiral rib is provided on the outer peripheral surface of the spiral propeller. In operation, the fruit or vegetable is put into the spiral propeller in the juicing cup from the feeding port, and is squeezed by the spiral propeller and the juicing cup. Meanwhile, under the action of the spiral rib of the spiral propeller, the fruit or vegetable residue is crushed and ground by the spiral rib as it moves downward, with the fruit juice passing through the meshes in the juicing cup and flowing into the juice receiving groove, and is then discharged from the juice discharge port in the juice receiving groove. The residue is pushed by the spiral propeller to the bottom of the juicing cup, and is discharged from a residue discharge port at the bottom of the juicing cup.

The counterforce of the fruit or vegetable residue on the spiral rib from bottom up causes slight vertical displacement of the spiral propeller, affecting the stability of the grinding capacity of the spiral propeller, and consequently affecting the juice yield. In addition, the typical spiral propeller features an integral structure including a cutting section and a grinding section arranged vertically. Limited by an integral forming process, the structure of the cutting section often does not have a good cutting ability, and the fruit or vegetable residue cannot be cut efficiently, affecting the efficiency of the juice machine.

### SUMMARY

In order to overcome the shortcomings of the prior art, one objective of the present disclosure is to provide a vertical juicing mechanism with higher grinding efficiency and stability and stronger cutting capability to improve the efficiency of juicing. Another objective of the present disclosure is to provide a juice machine using the above vertical juicing mechanism to obtain operational stability.

A vertical juicing mechanism according to an embodiment in a first aspect of the present disclosure includes: a juicing cup, where a separator is provided in the juicing cup, the separator is configured to divide an inner space of the juicing cup into a cutting cavity and a grinding cavity located below the cutting cavity, and a discharge port communicating the cutting cavity with the grinding cavity is provided on the separator; a feed impeller, rotatably provided in the juicing cup and located within the cutting cavity; and a spiral propeller, rotatably provided in the juicing cup, located within the grinding cavity, provided coaxially with the feed impeller, and capable of driving the feed impeller to rotate together, where a stop plane is provided at an upper end of the spiral propeller, a limit portion opposite to the stop plane is provided at a lower end face of the separator, and the stop plane is capable of abutting upwards against the limit portion to limit upward movement of the spiral propeller.

The vertical juicing mechanism according to an embodiment of the present disclosure has at least the following beneficial effects.

For the above-mentioned vertical juicing mechanism, the feed impeller in the cutting cavity is used for firstly crushing or cutting the material to be juiced with a smaller volume, and the feed impeller is used for conveying the material with a smaller volume from the discharge port to the grinding cavity, and further grinding the material to be juiced by rotating the spiral propeller, to improve the cutting capability and juicing efficiency. When the spiral propeller is subjected to a bottom-up counterforce from the material to be juiced, the stop plane can abut against the limit portion to limit the upward movement of the spiral propeller, ensuring upward movement and stable rotation of the spiral propeller to ensure grinding efficiency and stability.

In some embodiments of the present disclosure, an annular flange extending downward is formed at a middle position of the lower end face of the separator, the annular flange constitutes the limit portion, a rotating connector is rotatably provided in the annular flange, and upper and lower ends of the rotating connector are respectively connected to the feed impeller and the spiral propeller.

In some embodiments of the present disclosure, the feed impeller includes a stirring blade and a cutting blade which are circumferentially spaced around a rotation axis thereof, the stirring blade and the cutting blade each extend in a radial direction of the feed impeller to an inner circumferential edge of the juicing cup, and a free end of the stirring blade extends spirally upward above the feed impeller.

In some embodiments of the present disclosure, a cutting side edge is provided at a front end of the cutting blade in a clockwise direction of rotation of the feed impeller, and the cutting side edge is provided with a plurality of tool tips at intervals in an extending direction of the cutting side edge.

In some embodiments of the present disclosure, a first slope and a second slope are respectively provided at the front end and a rear end of the cutting blade in the clockwise direction of rotation of the feed impeller, the first slope and the second slope intersect to form a first ridge line, the first ridge line is parallel to the separator, and a height of the first ridge line is 10-15 mm.

In some embodiments of the present disclosure, an inner peripheral wall of the juicing cup is provided with ribbed slabs extending radially inward, a first crushing passage is provided between the stirring blade and the ribbed slabs, and a second crushing passage is provided between the cutting blade and the ribbed slabs.

In some embodiments of the present disclosure, the ribbed slabs include two ribbed slabs, one of the ribbed slabs is provided on the inner peripheral wall of the juicing cup adjacent to the discharge port, the other of the ribbed slabs is provided on the inner peripheral wall of the juicing cup facing away from the discharge port, and a reinforcing rib is connected to the ribbed slab facing away from the discharge port.

In some embodiments of the present disclosure, a truncated cone inclined surface with a wide top and a narrow bottom is provided between the inner peripheral wall of the juicing cup and the upper surface of the separator, lower ends of the ribbed slabs are formed on the truncated cone inclined surface, and the reinforcing rib is formed between an upper end of the corresponding ribbed slab and the inner peripheral wall of the juicing cup.

In some embodiments of the present disclosure, the stirring blade is respectively provided with a third slope and a fourth slope at front and rear sides of the stirring blade in the clockwise direction of rotation, the third slope and the fourth slope intersect to form a second ridge line, the third slope has a third ridge line extending spirally upwards towards the free end of the stirring blade, and the third ridge line is located above the second ridge line.

A juice machine according to an embodiment of a second aspect of the present disclosure includes the vertical juicing mechanism of any one of the above-mentioned technical solutions. The juice machine has higher grinding efficiency and stability, and stronger cutting ability to improve juicing efficiency.

Additional aspects and advantages of the present disclosure will be set forth in part in the description which follows and, in part, will be obvious from the description, or may be learned by practice of the present disclosure.

### BRIEF DESCRIPTION OF DRAWINGS

The present disclosure will be further described with reference to the accompanying drawings and embodiments.

FIG. 1 is a schematic internal cross-sectional diagram showing a vertical juicing mechanism according to an embodiment of the present disclosure;

FIG. 2 is a schematic diagram showing a combination of a juicing cup and a feed impeller of the embodiment of FIG. 1;

FIG. 3 is a schematic structural diagram of the feed impeller according to an embodiment of the present disclosure; and

FIG. 4 is an exploded view of a juice machine according to an embodiment of the present disclosure.

### DETAILED DESCRIPTION

Embodiments of the present disclosure will be described in detail below, examples of which are shown in the accompanying drawings, where throughout the same or similar reference numerals denote the same or similar elements or elements having the same or similar functions. The following embodiments described below with reference to the accompanying drawings are exemplary and serve merely to explain the present disclosure, and should not be construed as limiting the present disclosure.

In the description of the present disclosure, it is to be understood that, referring to orientation description, the instructed orientation or positional relationships, for example, the terms “upper”, “lower”, “front”, “rear”, “left”, “right”, “vertical”, “horizontal”, “top”, “bottom”, “inner”, “outer”, and the like are based on the orientation or positional relationships shown in the accompanying drawings, merely for ease of description of the present disclosure and simplification for the description, rather than indicating or implying that the device or element referred to must have a specific orientation and be constructed and operated in a specific orientation, which, therefore, cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, it is to be noted that, unless otherwise explicitly specified and defined, the terms “mounted”, “connected” and “connecting” are to be understood in a broad sense, e.g., as a fixed connection, a detachable connection, or an integrated connection; as a mechanical connection or an electrical connection; as a direct connection, an indirect connection through an intermediate medium, or a communication within two elements. Those of ordinary skill in the art can understood the specific meaning of the above terms in the present disclosure through specific situations.

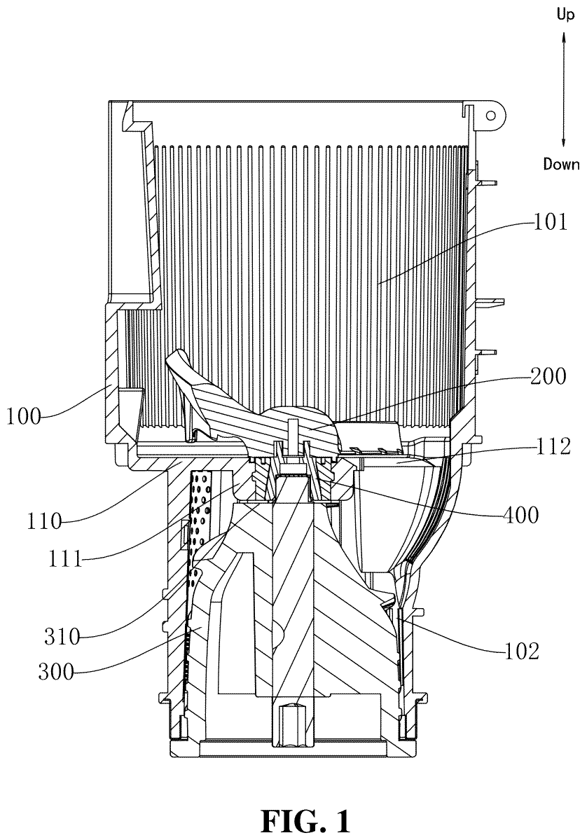

With reference to FIGS. 1 to 3, a vertical juicing mechanism of the present disclosure includes: a juicing cup 100, where a separator 110 is provided in the juicing cup 100, the separator 110 divides an inner space of the juicing cup 100 into a cutting cavity 101 and a grinding cavity 102 located below the cutting cavity 101, and a discharge port 112 communicating the cutting cavity 101 with the grinding cavity 102 is provided on the separator 110; a feed impeller 200, rotatably provided in the juicing cup 100 and located within the cutting cavity 101; and a spiral propeller 300, rotatably provided in the juicing cup 100, located within the grinding cavity 102, provided coaxially with the feed impeller 200, and capable of driving the feed impeller 200 to rotate together, where a stop plane 310 is provided at an upper end of the spiral propeller 300, a limit portion 111 opposite to the stop plane 310 is provided at a lower end face of the separator 110, and the stop plane 310 is capable of abutting upwards against the limit portion 111 to limit upward movement of the spiral propeller 300.

For the above-mentioned vertical juicing mechanism, the feed impeller 200 in the cutting cavity 101 is used for crushing or cutting the material to be juiced into a smaller volume, the feed impeller 200 is used to conveying the material with a smaller volume from the discharge port 112 to the grinding cavity 102, and then the material to be juiced is further ground through the rotation of the spiral propeller 300, which is suitable for a large block of juicing material, is beneficial to broaden the scope of application of the vertical juicing mechanism, and improves the cutting capability and juicing efficiency of the vertical juicing mechanism. When the spiral propeller 300 is subjected to a bottom-up counterforce from the material to be juiced, the stop plane 310 can abut against the limit portion 111 to limit the upward movement of the spiral propeller 300, ensuring the upward movement and stable rotation of the spiral propeller 300 to ensure grinding efficiency and stability. Moreover, since the feed impeller 200 crushes or cuts the material to be juiced with smaller volumes, the bottom-up counterforce from the material to be juiced against the spiral propeller 300 is also smaller. In addition, merely one drive motor is required to synchronously drive the spiral propeller 300 and the feed impeller 200 to synchronously rotate, simplifying the structure.

With reference to FIG. 1, in some embodiments of the present disclosure, an annular flange extending downward is formed at a middle position of the lower end face of the separator 110, the annular flange constitutes the limit portion 111. A rotating connector 400 is rotatably provided in the annular flange, and upper and lower ends of the rotating connector 400 are respectively connected to the feed impeller 200 and the spiral propeller 300. It can be understood that the annular flange serves both as a sleeve for the rotating connector 400 and as the limit portion 111 to facilitate compactness. When the spiral propeller 300 rotates, the feed impeller 200 can be driven to rotate together via the rotating connector 400. Both ends of the rotating connector 400 are engaged with the feed impeller 200 and the spiral propeller 300 in a plug-in manner, respectively, to transmit torque, which will not be described in further detail here.

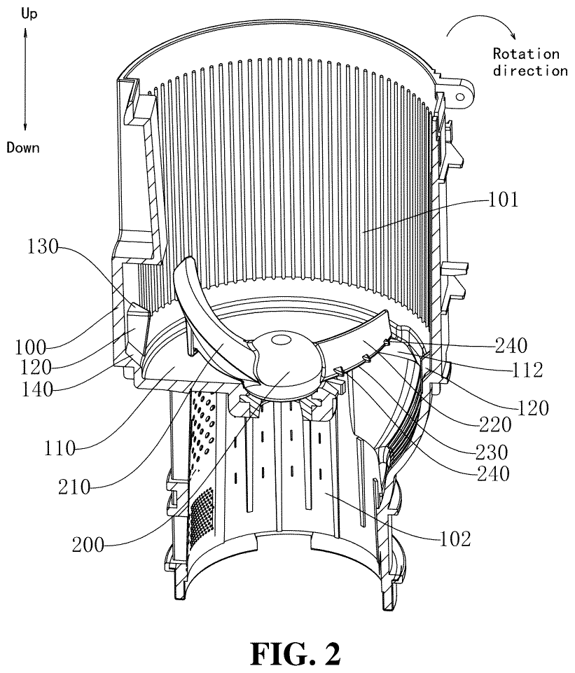

With reference to FIG. 2, in some embodiments of the present disclosure, the feed impeller 200 includes a stirring blade 210 and a cutting blade 220 which are circumferentially spaced around a rotation axis thereof, the stirring blade 210 and the cutting blade 220 each extend in a radial direction of the feed impeller 200 to an inner circumferential edge of the juicing cup 100, and a free end of the stirring blade 210 extends spirally upward above the feed impeller 200. It can be understood that the stirring blade 210 and the cutting blade 220 both extend to the inner circumferential edge of the juicing cup 100 to cooperate with the inner wall of the juicing cup 100 to crush or cut the juicing material. The stirring blade 210 mainly functions to chop and break the juicing material put into the juicing cup 100, and the cutting blade 220 mainly functions to cooperate with the discharge port 112 to cut the juicing material which has been chopped and broken. It should be noted that the cutting blade 220 is adjacent to the upper surface of the separator 110 and, as the cutting blade 220 rotates to pass through the discharge port 112, can push the juicing material against the inner edge of the discharge port 112 to cut and push the juicing material into the grinding cavity 102. In particular, the feed impeller 200, consisting of the stirring blade 210 and the cutting blade 220, is substantially horn-shaped, and the spirally upwardly extending stirring blade 210 facilitates directing the juicing material downwardly within the working area of the cutting blade 220.

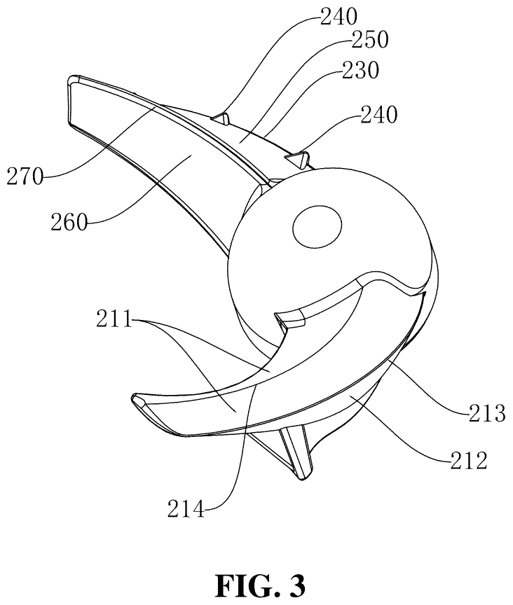

Referring to FIGS. 2 and 3, in some embodiments of the present disclosure, a cutting side edge 230 is provided at a front end of the cutting blade 220 in a clockwise direction of rotation of the feed impeller 200, and the cutting side edge 230 is provided with a plurality of tool tips 240 at intervals in the extending direction thereof. It needs be noted that as the cutting blade 220 contacts the juicing material, the cutting side edge 230 comes into contact with the juicing material first, and the provision of a plurality of tool tips 240 facilitates breaking up or segmenting the juicing material such as pulp.

Referring to FIGS. 2 and 3, in some embodiments of the present disclosure, a first slope 250 and a second slope 260 are respectively provided at the front end and a rear end of the cutting blade 220 in the clockwise direction of rotation, the first slope 250 and the second slope 260 intersect to form a first ridge line 270, the first ridge line 270 is parallel to the separator 110, and a height of the first ridge line 270 is 10-15 mm. It needs to be noted that, in general, the cross-sectional areas of the stirring blade 210 and the cutting blade 220 decrease in a direction away from the rotation axis of the feed impeller 200, and accordingly, the edge line where the first slope 250 and the second slope 260 intersect also decreases in a direction away from the rotation axis of the feed impeller 200, resulting in a tendency for part of the juicing material to pass over the first slope 250 to the rear of the second slope 260 immediately when the juicing material contacts the cutting side edge 230, thereby being unable to cut and deliver the juicing material to the grinding cavity 102. The height of the first ridge line 270 parallel to the upper surface of the separator 110 is about 10-15 mm, which helps to alleviate the problem of smaller juicing material passing over the first slope 250.

Referring to FIG. 2, in some embodiments of the present disclosure, in order to improve the efficiency of the feed impeller 200 in first crushing or cutting the material to be juiced with smaller volumes, an inner peripheral wall of the juicing cup 100 is provided with ribbed slabs 120 extending radially inward, a first crushing passage is provided between the stirring blade 210 and each of the ribbed slabs 120, and a second crushing passage is provided between the cutting blade 220 and each of the ribbed slabs 120. That is, as the feed impeller 200 rotates, the juicing material with larger volume rotates by the stirring blade 210 and is blocked by the respective ribbed slab 120 to pass through the first crushing passage to form a smaller volume, and then the juicing material is rotated and pushed by the cutting blade 220 to move along the upper surface of the separator 110 to pass through the second crushing passage to form the juicing material passing through the discharge port 112.

With reference to FIG. 2, in some embodiments of the present disclosure, the number of the ribbed slabs 120 provided is two, one of the ribbed slabs 120 is provided on the inner peripheral wall of the juicing cup 100 adjacent to the discharge port 112, the other of the ribbed slabs 120 is provided on the inner peripheral wall of the juicing cup 100 facing away from the discharge port 112, and a reinforcing rib 130 is connected to the ribbed slab 120 facing away from the discharge port 112. Since the ribbed slab 120 facing away from the discharge port 112 needs to cooperate with the stirring blade 210 to crush the input juicing material, the ribbed slab 120 is subjected to a large force, and the arrangement of the reinforcing rib 130 can reduce the possibility of the ribbed slab 120 breaking up.

With reference to FIG. 2, in some embodiments of the present disclosure, a truncated cone inclined surface 140 with a wide top and a narrow bottom is provided between the inner peripheral wall of the juicing cup 100 and the upper surface of the separator 110, and the juicing material put into the cutting cavity 101 can slide down onto the separator 110 along the truncated cone inclined surface 140. In order to further simplify the manufacturing process, lower ends of the ribbed slabs 120 are formed on the truncated cone inclined surface 140, and the reinforcing rib 130 is formed between the upper end of the respective ribbed slab 120 and the inner peripheral wall of the juicing cup 100.

With reference to FIG. 3, in some embodiments of the present disclosure, the stirring blade 210 is respectively provided with a third slope 211 and a fourth slope 212 at the front and rear sides of the stirring blade 210 in the clockwise direction of rotation, the third slope 211 and the fourth slope 212 intersect to form a second ridge line 213, the third slope 211 has a third ridge line 214 extending spirally upwards towards the free end of the stirring blade 210, and the third ridge line 214 is located above the second ridge line 213. If the surface of the third slope 211 is smooth or rounded, the slice-shaped juicing material easily adheres to the third slope 211 and cannot enter the working area of the cutting blade 220. In the above structure, by providing the third slope 211 of the stirring blade 210 with a third ridge line 214, the slice-shaped juicing material cannot adhere to the third slope 211.

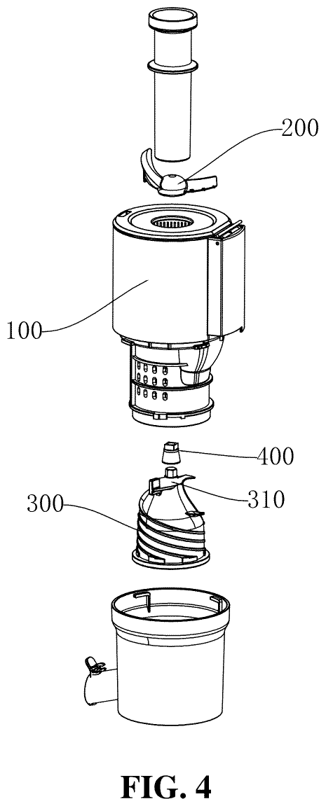

With reference to FIG. 4, the present disclosure further discloses a juice machine including a vertical juicing mechanism of any one of the above-mentioned technical solutions. The juice machine has higher grinding efficiency and stability, and stronger cutting ability to improve juicing efficiency.

Technical features of the above-mentioned embodiments can be combined in any way. In order to make the description concise, not all the possible combinations of the technical features in the above-mentioned embodiments are described. However, as long as there is no contradiction between the combinations of these technical features, they should be considered as the scope of the description.

Although embodiments of the present disclosure have been shown and described, it can be understood by those of ordinary skill in the art that various changes, modifications, substitutions and variations can be made to these embodiments without departing from the principles and gist of the present disclosure, the scope of which is defined by the claims and their equivalents.

What is claimed is:

1. A vertical juicing mechanism, comprising:
a juicing cup, wherein a separator is provided in the juicing cup, the separator is configured to divide an inner space of the juicing cup into a cutting cavity and a grinding cavity located below the cutting cavity, and a discharge port communicating the cutting cavity with the grinding cavity is provided on the separator;
a feed impeller, rotatably provided in the juicing cup and located within the cutting cavity; and
a spiral propeller, rotatably provided in the juicing cup, located within the grinding cavity, provided coaxially with the feed impeller, and capable of driving the feed impeller to rotate together, wherein a stop plane is provided at an upper end of the spiral propeller, a limit portion opposite to the stop plane is provided at a lower end face of the separator, and the stop plane is capable of abutting upwards against the limit portion to limit upward movement of the spiral propeller.

2. The vertical juicing mechanism according to claim 1, wherein
an annular flange extending downward is formed at a middle position of the lower end face of the separator, the annular flange constitutes the limit portion, a rotating connector is rotatably provided in the annular flange, and upper and lower ends of the rotating connector are respectively connected to the feed impeller and the spiral propeller.

3. The vertical juicing mechanism according to claim 1, wherein
the feed impeller comprises a stirring blade and a cutting blade which are circumferentially spaced around a rotation axis of the feed impeller, the stirring blade and the cutting blade each extend in a radial direction of the feed impeller to an inner circumferential edge of the juicing cup, and a free end of the stirring blade extends spirally upward above the feed impeller.

4. The vertical juicing mechanism according to claim 3, wherein
a cutting side edge is provided at a front end of the cutting blade in a clockwise direction of rotation of the feed impeller, and the cutting side edge is provided with a plurality of tool tips at intervals in an extending direction of the cutting side edge.

5. The vertical juicing mechanism according to claim 4, wherein
a first slope and a second slope are respectively provided at the front end and a rear end of the cutting blade in the clockwise direction of rotation of the feed impeller, the first slope and the second slope intersect to form a first ridge line, the first ridge line is parallel to the separator, and a height of the first ridge line is 10-15 mm.

6. The vertical juicing mechanism according to claim 3, wherein
an inner peripheral wall of the juicing cup is provided with ribbed slabs extending radially inward, a first crushing passage is provided between the stirring blade and the ribbed slabs, and a second crushing passage is provided between the cutting blade and the ribbed slabs.

7. The vertical juicing mechanism according to claim 6, wherein
the ribbed slabs comprise two ribbed slabs, one of the ribbed slabs is provided on the inner peripheral wall of the juicing cup adjacent to the discharge port, the other of the ribbed slabs is provided on the inner peripheral wall of the juicing cup facing away from the discharge port, and a reinforcing rib is connected to the ribbed slab facing away from the discharge port.

8. The vertical juicing mechanism according to claim 7, wherein
a truncated cone inclined surface with a wide top and a narrow bottom is provided between the inner peripheral wall of the juicing cup and the upper surface of the separator, lower ends of the ribbed slabs are formed on the truncated cone inclined surface, and the reinforcing rib is formed between an upper end of the corresponding ribbed slab and the inner peripheral wall of the juicing cup.

9. The vertical juicing mechanism according to claim 3, wherein
the stirring blade is respectively provided with a third slope and a fourth slope at front and rear sides of the stirring blade in a clockwise direction of rotation, the third slope and the fourth slope intersect to form a second ridge line, the third slope has a third ridge line extending spirally upwards towards the free end of the stirring blade, and the third ridge line is located above the second ridge line.

10. A juice machine, comprising a vertical juicing mechanism comprising:
a juicing cup, wherein a separator is provided in the juicing cup, the separator is configured to divide an inner space of the juicing cup into a cutting cavity and a grinding cavity located below the cutting cavity, and a discharge port communicating the cutting cavity with the grinding cavity is provided on the separator;
a feed impeller, rotatably provided in the juicing cup and located within the cutting cavity; and
a spiral propeller, rotatably provided in the juicing cup, located within the grinding cavity, provided coaxially with the feed impeller, and capable of driving the feed impeller to rotate together, wherein a stop plane is provided at an upper end of the spiral propeller, a limit portion opposite to the stop plane is provided at a lower end face of the separator, and the stop plane is capable of abutting upwards against the limit portion to limit upward movement of the spiral propeller.

11. The juice machine according to claim 10, wherein
an annular flange extending downward is formed at a middle position of the lower end face of the separator, the annular flange constitutes the limit portion, a rotating connector is rotatably provided in the annular flange, and upper and lower ends of the rotating connector are respectively connected to the feed impeller and the spiral propeller.

12. The juice machine according to claim 10, wherein
the feed impeller comprises a stirring blade and a cutting blade which are circumferentially spaced around a rotation axis of the feed impeller, the stirring blade and the cutting blade each extend in a radial direction of the feed impeller to an inner circumferential edge of the juicing cup, and a free end of the stirring blade extends spirally upward above the feed impeller.

13. The juice machine according to claim 12, wherein
a cutting side edge is provided at a front end of the cutting blade in a clockwise direction of rotation of the feed impeller, and the cutting side edge is provided with a plurality of tool tips at intervals in an extending direction of the cutting side edge.

14. The juice machine according to claim 13, wherein
a first slope and a second slope are respectively provided at the front end and a rear end of the cutting blade in the clockwise direction of rotation of the feed impeller, the first slope and the second slope intersect to form a first ridge line, the first ridge line is parallel to the separator, and a height of the first ridge line is 10-15 mm.

15. The juice machine according to claim 12, wherein
an inner peripheral wall of the juicing cup is provided with ribbed slabs extending radially inward, a first crushing passage is provided between the stirring blade and the ribbed slabs, and a second crushing passage is provided between the cutting blade and the ribbed slabs.

16. The juice machine according to claim 15, wherein
the ribbed slabs comprise two ribbed slabs, one of the ribbed slabs is provided on the inner peripheral wall of the juicing cup adjacent to the discharge port, the other of the ribbed slabs is provided on the inner peripheral wall of the juicing cup facing away from the discharge port, and a reinforcing rib is connected to the ribbed slab facing away from the discharge port.

17. The juice machine according to claim 16, wherein
a truncated cone inclined surface with a wide top and a narrow bottom is provided between the inner peripheral wall of the juicing cup and the upper surface of the separator, lower ends of the ribbed slabs are formed on the truncated cone inclined surface, and the reinforcing rib is formed between an upper end of the corresponding ribbed slab and the inner peripheral wall of the juicing cup.

18. The juice machine according to claim 12, wherein
the stirring blade is respectively provided with a third slope and a fourth slope at front and rear sides of the stirring blade in a clockwise direction of rotation, the third slope and the fourth slope intersect to form a second ridge line, the third slope has a third ridge line extending spirally upwards towards the free end of the stirring blade, and the third ridge line is located above the second ridge line.
